(19) United States
(12) Patent Application Publication
(10) Pub. No.: US 2005/0073436 A1
(43) Pub. Date: Apr. 7, 2005

(54) Method and system for alerting a patrol officer of a wanted vehicle

(76) Inventor: Manuel I. Negreiro, Fort Worth, TX (US)

Correspondence Address: DECKER, JONES, MCMACKIN, MCCLANE, HALL &;BATES, P.C., BURNETT PLAZA 2000, 801 CHERRY STREET, UNIT #46, FORT WORTH, TX, 76102-6836, US

(21) Appl. No.: 10/922,348

(22) Filed: Aug. 20, 2004

Related U.S. Application Data
(60) Provisional application No. 60/481,279, filed on Aug. 22, 2003.

(51) Int. Cl. G08G 1/017

(52) U.S. Cl. 340/937; 348/148; 707/10; 340/901

(57) ABSTRACT

A method of alerting a patrol officer of a wanted vehicle begins with providing a database of wanted vehicles in a first vehicle. Records in the database include identifying characteristics and a record rating that indicates a type of warrant for the wanted vehicle. A current priority threshold is set. Using a camera on the first vehicle, a digital image of a second vehicle is captured. The digital image is processed to recognize identifying characteristics of the second vehicle. The identifying characteristics may be a vehicle license number. The database of wanted vehicles is queried for a record having the identifying characteristics. In response to finding a matching record having a record rating equal to or exceeding the current priority threshold, an alert is produced in the first vehicle. The alert may be audible or visual, and may indicate the relative position of the first and second vehicles.

### CROSS-REFERENCE TO RELATED APPLICATIONS

This application claims the benefit of U.S. Provisional Application No. 60/481,279, filed Aug. 22, 2003.

### BACKGROUND OF THE INVENTION

The present invention relates generally to methods and systems for finding, identifying, and alerting a vehicle occupant of a nearby vehicle wanted for law enforcement or security reasons, and more specifically to methods and systems for automatically digitally recognizing vehicles listed in a database of wanted vehicles, and providing an alert under specified circumstances.

Traffic stops play an important part in the effectiveness of law enforcement. Frequently, police officers are on patrol, near a vehicle driven by a person wanted for a crime, or a person wanted for unpaid traffic tickets, or the is nearby vehicle may be a stolen vehicle. The opportunity for the officer to stop the vehicle and investigate depends largely upon the officer's memory or instincts. If finding these wanted and suspect vehicles was easier or more efficient, law enforcement may be improved and public safety may be increased.

Law enforcement could be improved and public safety increased if the identification of these wanted and suspect vehicles became easier and more efficient. In urban traffic environments, the officer may be surrounded by a large number of vehicles. Attempting to manually identify suspect or wanted vehicles out of the large number of vehicles is typically a hit or miss affair. For example, the capture of Timothy McVeigh, convicted of the Oklahoma City bombing, was a result of a fortuitous traffic stop.

Law enforcement agencies that may benefit from an increased ability to identify and be alerted to nearby vehicles that are wanted, for any of several reasons, include the Central Intelligence Agency (CIA), the Federal Bureau of Investigation (FBI), and the National Security Agency (NSA). In some instances a vehicle is wanted, and in other instances the driver may be wanted. A system that identifies and alerts a user of selected nearby vehicles may also be used by bounty hunters or persons that repossess vehicles. Such a system may also be used by campus security guards in a guard shack or other fixed facility at a campus vehicle entrance. This use may include identifying vehicles of former employees or other persons who are not welcome on campus.

Some systems have been proposed to aid officers in identifying vehicles for a traffic stop. For example, U.S. Pat. No. 5,425,108, issued to Hwang, et al., discloses a car-mounted system for automatically identifying a car license plate, even while the patrol car is moving. The system uses image processing, including a “fuzzy inference” and a “character structure analysis neural network” for reading the characters of the license plate. U.S. Pat. No. 5,425,108 is hereby incorporated by reference.

Other patents that use image processing to identify vehicles include U.S. Pat. No. 5,568,406 issued to Gerber, U.S. Pat. No. 5,651,075 issued to Frazier, et al., U.S. Pat. No. 5,315,664 issued to Kumagia, U.S. Pat. No. 5,136,658 issued to Mori, U.S. Pat. No. 5,081,685 issued to Jones, III, et al., U.S. Pat. No. 4,878,248 issued to Shyu, et al., U.S. Pat. No. 4,817,166 issued to Gonzalez, et al., U.S. Pat. No. 4,567,609 issued to Metcalf, each of which is incorporated herein by reference.

Once a license plate is recognized, the plate number may be searched in a database of wanted vehicles. One problem with searching such a database is that the database may not be current, which may cause the officer to miss an opportunity to stop a wanted vehicle.

Another problem with systems that recognize wanted vehicles is in the method and timing of the alert to the patrol officer in the official vehicle. The alert may not clearly indicate to the officer where the wanted vehicle is located in relation to the official vehicle. Without a clear indication, the officer is alerted that a wanted vehicle is near, but the wanted vehicle may be one of several nearby vehicles. Hence, there is a need for further information in the alert.

At certain times during the patrol shift, alerts may be considered unimportant or a nuisance. For example, an officer may be annoyed by frequent alerts for small infractions. If an officer is annoyed with the alert system, it may become less effective because the officer will not want to use it.

Therefore, there is a need for an improved method and system for recognizing wanted vehicles and alerting officers in an official vehicle, wherein the alert may help distinguish the wanted vehicle from other nearby vehicles, and the alert is delivered to the officer at an appropriate time, and for selected wanted vehicles that meet current criteria of the law enforcement agency.

### BRIEF SUMMARY OF THE INVENTION

The present invention provides a method for alerting a patrol officer in a first vehicle of a nearby wanted second vehicle. A database of wanted vehicles is provided, wherein records in the database include identifying characteristics of wanted vehicles, and a record rating that indicates a type of warrant associated with the wanted vehicle. A current priority threshold is set in the first vehicle. A digital image of the second vehicle is captured using a digital camera on the first vehicle. Next, the digital image is processed to recognize identifying characteristics of the second vehicle, such as a license plate number. The database of wanted vehicles is then searched for a record having the identifying characteristics. In response to finding a matching record having a record rating equal to or exceeding the current priority threshold, the system produces an alert in the first vehicle. The alert may be audible or visual, and may indicate the position of the second vehicle relative to the first vehicle.

The present invention further provides a system for alerting a patrol officer of a wanted vehicle. The system includes a camera for mounting on a first vehicle for capturing a digital image of a second vehicle. A digital image processor is coupled to the camera for processing the digital image to recognize identifying characteristics of the second vehicle. A database management unit receives the identifying characteristics and is used to query a database of wanted vehicles using the identifying characteristics to find a matched record. Records in the database include vehicle identifying characteristics and a record rating that indicates a type of warrant associated with the wanted vehicle. A central processing unit is coupled to the database management unit for setting a current priority threshold in the first vehicle and for producing an alert signal in the first vehicle in response to the record rating in the matched record being equal to or exceeding the current priority threshold. An alerting device coupled to the central processing unit is used for producing an alert in the first vehicle in response to the alert signal.

### BRIEF DESCRIPTION OF THE DRAWINGS

FIG. 1 is a side view an official vehicle having an imaging system mounted thereon in accordance with the method and system of the present invention;

FIG. 2 is a high-level block diagram showing the interconnection of the functional units of the method and system of the present invention;

FIG. 3 is a high-level diagram of data distribution and storage in a data communication network in accordance with the method and system of the present invention;

FIGS. 4 and 5 are high-level logical flow charts of the operation of the method and system of the present invention;

FIGS. 6 and 7 illustrate a video display that may be used inside an official vehicle in accordance with the method and system of the present invention; and

FIG. 8 depicts records and fields in a database that may be used in accordance with the method and system of the present invention.

### DETAILED DESCRIPTION OF THE INVENTION

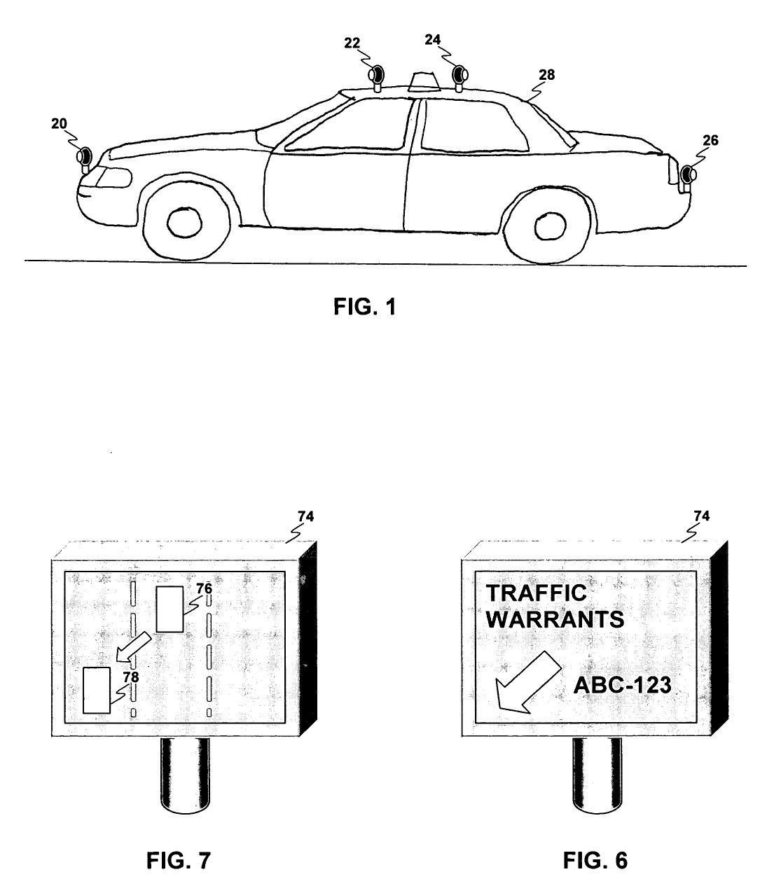

As shown in FIG. 1, the system for alerting a patrol officer according to the present invention includes one or more digital cameras, such as digital cameras 20-26, mounted in one or more places on official vehicle 28. In a preferred embodiment, digital cameras 20-26 are capable of rapidly capturing high resolution video data, which may include digital images of near-by vehicles and their vehicle license plates. Digital cameras 20-26 may be mounted in many places on official vehicle 28, such as on the front of the car, on the front bumper or grill of the car (like digital camera 20), or on the roof of the car facing either forward or backward (like digital cameras 22 and 24), or on the rear of the car on the rear bumper of the official vehicle 28 (like digital camera 26). While digital cameras 20-26 may be mounted externally in a visible location as shown in FIG. 1, they may also be concealed inside the official vehicle, or hidden in the grill, or bumper, or trunk of the vehicle. Digital cameras may also be mounted so that they can pan and tilt to provide a better view. Cameras can also be mounted so as to view the areas to the side of the vehicle 28, which allows the camera to capture images of vehicles in traffic lanes to the side of official vehicle 28. Digital cameras 20-26 are preferably located to scan or otherwise capture digital images of all vehicles within range of the system.

Each of the digital cameras may be a very simple TV camera, designed to take still pictures all the time and pass such pictures to an image processor containing optical character recognition software. In a preferred embodiment, a low profile CCD camera can be mounted on the front bumper and in the trunk of the law enforcement vehicle. A focal length of the camera may be fixed, and may be set to focus at a selected distance with a selected light sensitivity, depending on the usage and conditions where the vehicle is going to operate. Digital cameras 20-26 are connected to the remaining portions of the system within official vehicle 28 for further image and data processing.

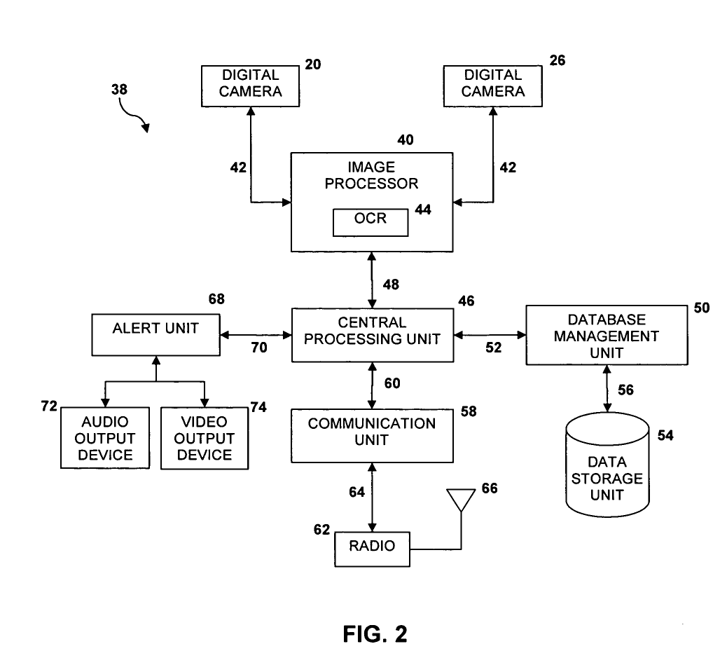

With reference now to FIG. 2, there is depicted a high-level functional schematic diagram of the vehicle detection and alert system 38 of the present invention. As illustrated, digital cameras, such as 20 and 26, are coupled to image processor 40 via data communication links 42. Image processor 40 captures and stores digital data or digital images from one or more digital cameras 20 and 26.

Data communication links 42 may be either serial or parallel data links. In a preferred embodiment, data links 42 transfer data at high speed so that digital image data is quickly transferred and captured in memory in image processor 40.

Image processor 40 includes an optical character recognition (OCR) function 44, which is preferably used to analyze selected portions of the captured digital images to determine what alpha numeric characters are present.

Image processor 40 is coupled to central processing unit (CPU) 46 via data bus 48. Central processing unit 46 may be implemented with a general purpose computer, operating under the control of specialized software. Image processor 40 passes identifying characteristics of nearby vehicles, such as character information, to central processing unit 46. Image processor 40 may also pass additional information to central processing unit 46, such as information about the location of the vehicle in the image. This location information may represent the relative position of the imaged vehicle with respect to the official vehicle.

Central processing unit 46 is also coupled to database management unit 50 via bus 52. Database management unit 50 preferably includes a search engine to handle searches and queries of data stored in data storage unit 54. Database management unit 50 may include database software and functions that query data stored in files, which information may be stored in RAM, memory cards, hard disks, optical disks, or other common storage media. Database management unit 50 is coupled to data storage unit 54 using data bus 56. In some embodiments, database management unit 50, data storage 54 and busses 52 and 54 may be implemented with hardware and software within a general purpose computer, which computer may also be used as central processing unit 46.

Central processing unit 46 is also coupled to communication unit 58 via data bus 60. Communication unit 58 may be used to receive, update, and otherwise manage data files, which may be stored in data storage unit 54. Communication unit 58 may use check sums and error other detection and correction techniques in order to maintain data integrity over a communication link used to communicate data.

To send and receive data files and commands, communication unit 58 may be coupled to radio 62 via data link 64. Radio 62 may include antenna 66, which is preferably mounted high on the exterior of official vehicle 28.

Communication unit 58 and radio 62 form the mobile portion of a radio data link between official vehicle 28 and a local database, which local database may be maintained at a local police station or police substation. The radio communication link may be implemented on a sub-band portion of an existing police band system. If the database managed by database management unit 50 is large, the radio data link may be required to transfer large amounts of data. If sub-band radio communication is used, the database data may be sent continuously over the radio waves so that a large database may be transferred over the relatively slow data rate of the sub-band radio. In a preferred embodiment, additional communication efficiency may be obtained if only the changes in the database, or database updates, are transmitted. When data is transmitted continuously, communication unit 58 or database management unit 50 is able to distinguish new data from old data, so that new data can replace old data as it is received.

Communication unit 58 and radio 62 may also receive new programming or software via the wireless data link. When a new program is received, central processing unit 46 may switch from the old program to the new program, thereby changing the functions or the operation of the vehicle detection and alert system 38.

In an emergency situation, urgent data can be downloaded with an associated code or tag indicating that the information needs immediate attention, and that the officer should be alerted the as soon as the data is downloaded.

Central processing unit 46 may also be coupled to alert unit 68 via data link 70. The purpose of alert unit 68 is to provide alert information that informs the officer of the reason for the alert, at the appropriate time, and in a manner that helps the officer locate the vehicle that has triggered the alert. To perform the alert function, alert unit 68 may be coupled to audio output device 72 or video output device 74, or both. Audio output device 72 may sound an alert tone, may use speech synthesis to create a spoken alert, or may use other similar audible alert techniques.

Display or video output device 74 may provide a screen with graphical or textual data explaining the alert. Examples of displays that may be provided on video output device 74 are shown in FIGS. 6 and 7. In FIG. 6, textual data and graphical data is displayed. The textual data includes the license plate number. The graphical data includes an arrow that indicates the location of the wanted vehicle with respect to official vehicle 28. In the example shown in FIG. 6, the displayed alert indicates that a wanted vehicle is to the left and to the rear of official vehicle 28, and the vehicle has a license plate of “ABC-123”. In the example of FIG. 7, the position of official vehicle 28 is shown at reference numeral 76, and the wanted vehicle is shown at reference numeral 78, where it is displayed in relative position to official vehicle 76.

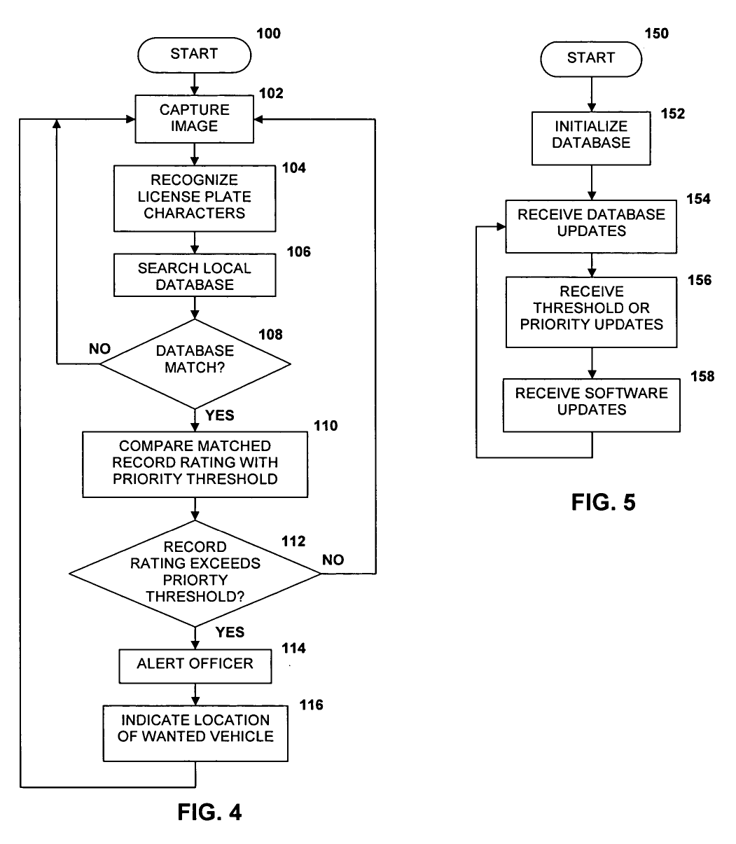

With reference now to FIGS. 4 and 5, there are depicted high-level logic flowcharts of the operation of the method and system of the present invention. The processes of FIGS. 4 and 5 are implemented by vehicle detection and alert system 38 shown in FIG. 2. As illustrated, the process begins at block 100, and thereafter passes to block 102, wherein the system captures a digital image of an area surrounding official vehicle 28 (See FIG. 1). The image is preferably captured with a digital camera, such as digital cameras 20-26 shown in FIG. 1. The digital image should be of a quality and resolution that will allow an optical character recognition system to locate and recognize characters on license plates or other identifying characteristics of vehicles present in the captured image.

After capturing an image, the process uses digital image processing to recognize license plate characters on license plates of vehicles present in the image, as illustrated at block 104. The process of recognizing license plate characters begins by locating a license plate in the image. After the license plate is located, the process uses known techniques of optical character recognition, which techniques are conventional and available in commercial software. The optical character recognition may be implemented in software and hardware in image processor 40 and central processing unit 46, which are shown in FIG. 2. Digital image processing may also be used to recognize other vehicle identifying characteristics, such as color and type of vehicle, and the like.

Once the license plate characters are recognized, the characters are passed to a database search engine to perform a search or query of the local database, as depicted in block 106. In a preferred embodiment, the wanted vehicle database is stored in a computer system, such as vehicle detection and alert system 38 shown in FIG. 2, within official vehicle 28. Alternatively, the database may be located external to official vehicle 28, such as in a police station, or other centralized data processing location. By using a local database within official vehicle 28, the time required to look up a vehicle identification number or license plate number may be reduced, which may increase the number of license plates checked per unit of time. Additionally, faster lookups increase the likelihood that the wanted vehicle is still near the officer so the officer can stop the vehicle.

When the result of the database query is returned, the system determines whether or not a matching record was found in the database, as illustrated at decision block 108. If a database matching record was not found, the process iteratively returns to block 102, wherein another image is captured and the process begins again. The steps of image capture, recognition, and database searching may operate continuously in the background, scanning all vehicles within system range, while a patrol officer ordinarily performs his or her duties.

Once the system detects a match, the system decides what to do with the matching information. If at block 108 a database matching record is found, the process compares a matched-record rating with a priority threshold or other criteria for processing a match, as depicted at block 110. In the database, each record preferably has a record rating, or a similar form of classification or ranking, that indicates the importance, or severity, or type of warrant or offense associated with the person that is likely to be driving or riding in the vehicle. This rating system is used to manage alerts that may be given to the officer driving official vehicle 28. For example, a database match having a record rating that is below a selected rating or current priority threshold may not cause an alert to be given to the officer, while another database match having a higher rating above a current priority threshold may cause an alert to the officer.

The current priority threshold is a rating level that may be selected by the officer, or may be selected by the officer's superior and sent to official vehicle 28 via the wireless data link. The current priority threshold tells the system which matches in the database should cause an officer alert in the official vehicle. If the current priority threshold is set low, the officer will be alerted to vehicles or likely passengers wanted for any offence or warrant above a relatively minor offence threshold, such as anything above or more serious than outstanding parking tickets. If the current priority threshold is set to a higher level, the officer is only alerted to wanted vehicles or likely passengers having a higher rating, such as vehicles involved in an “Amber Alert” (i.e., an alert for a vehicle that may be connected with the recent abduction of a child), or a vehicle seen during a bank robbery, or the like. When the current priority threshold is set higher, a detection of a lower-rated wanted vehicle will not trigger an alert.

The current priority threshold or alert criteria may be more complicated, and include more tests of more criteria. For example, alerts could be based upon a type of warrant, a quality of a warrants, and/or a quantity of warrants. A threshold may, for example, specify that an officer should be alerted to vehicles having more than 5 (a quantity) traffic tickets (a type or quality of violation or warrant). The system may also be set to alert the officer to vehicles that meet certain criteria, such as a vehicle that is associated with a registered sex offender, or a stolen vehicle, or a vehicle of an owner that is wanted for arrest, or a vehicle that is the subject of a local or national security alert, or a vehicle that is the subject of an unpaid traffic violation, or other similar criteria.

After comparing the matched-record rating, the system determines whether or not the record rating exceeds the current priority threshold, as illustrated in block 112. If the record rating does not exceed the current priority threshold, the process iteratively returns to block 102 for capturing a new image. Alternatively, the officer could be notified of the alert and allowed to decide what to do with the data matched in the database.

If the record rating exceeds the current priority threshold, the process passes to block 114, wherein the officer is alerted in official vehicle 28. The alert may take the form of an alert tone or sound that is output by a speaker in the vehicle. Alternatively, the alert may include a speech-synthesized voice that explains the details of the alert, and may include information indicating the location of the wanted vehicle. The alert may also include text or graphics displayed on a video output device, such as video output device 74 in FIG. 2.

In some embodiments of the invention, the system may determine that an alert should not be given, based upon the present activity of the officer. For example, if the officer is in pursuit with the emergency lights flashing, the system may decide not to alert that a vehicle with parking violations is nearby. In this implementation, inputs may be provided to CPU 46 by sensors in vehicle 28 to indicate when the emergency lights are on or off.

In addition to alerting the officer, the process may also indicate the location of the wanted vehicle, as illustrated in block 116. As shown in FIGS. 6 and 7, the indication of the wanted vehicle may be implemented with a video display device that displays graphics or text that aids the officer in determining the location of the wanted vehicle. The graphics may include arrows that indicate a direction from the official vehicle, or the graphics may include diagrams or icons that indicate the wanted vehicle's position relative to the official vehicle. The video output device may also display a picture of the wanted vehicle. If a picture is displayed, color pictures may be useful in giving the officer information about the year, make, model, and color of the vehicle.

With reference now to FIG. 5, there is depicted a high-level, logic flowchart of a background process, which may be implemented concurrently with the process of FIG. 4, for maintaining the software and the database in accordance with the method and system of the present invention. The flowchart of FIG. 5 is for illustration only, and steps 154-158 need not occur in the sequence shown. The steps may be implemented when a particular update is received. An update may have identifying information about what type of update it is. As illustrated, the process begins at block 150 and thereafter passes to block 152, wherein the database is initialized at system startup. The initialization process may conduct a data integrity check, add or delete records, reformat records, or perform other similar operations as instructed by commands that have been previously received.

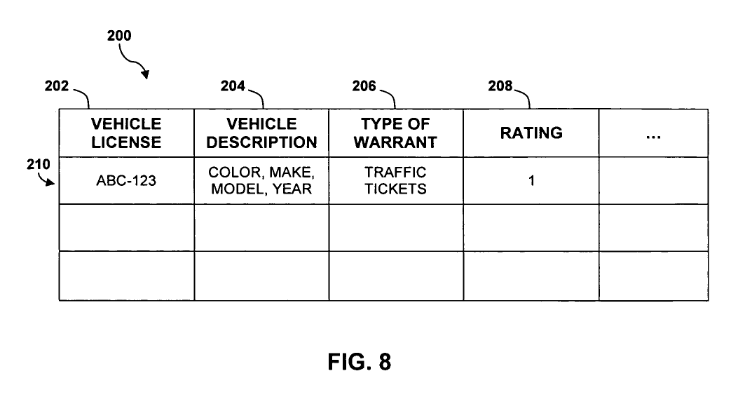

After initializing the database, the process receives any database updates that may have been recently transmitted, as depicted at block 154. Database updates may instruct database management unit 50 (See FIG. 2) to add, delete, modify, reformat, or otherwise manage and manipulate data in the database. A more specific discussion of the data in the database is provided below in relation to FIG. 8. Database updates may be forwarded from communication unit 58 to database management unit 50, under the control of central processing unit 46.

Next, the process may receive threshold or current priority threshold updates, as illustrated in block 156. The current priority threshold updates may instruct vehicle detection and alert system 38 to change the current priority threshold, or similar criteria, for alerting officers in official vehicle 28. The current priority threshold updates may also instruct database management unit 50 to change a rating of a record in the database. Therefore, such threshold and priority updates generally consist of commands or data that will change how or when officers in official vehicle 28 are alerted when a database match is detected.

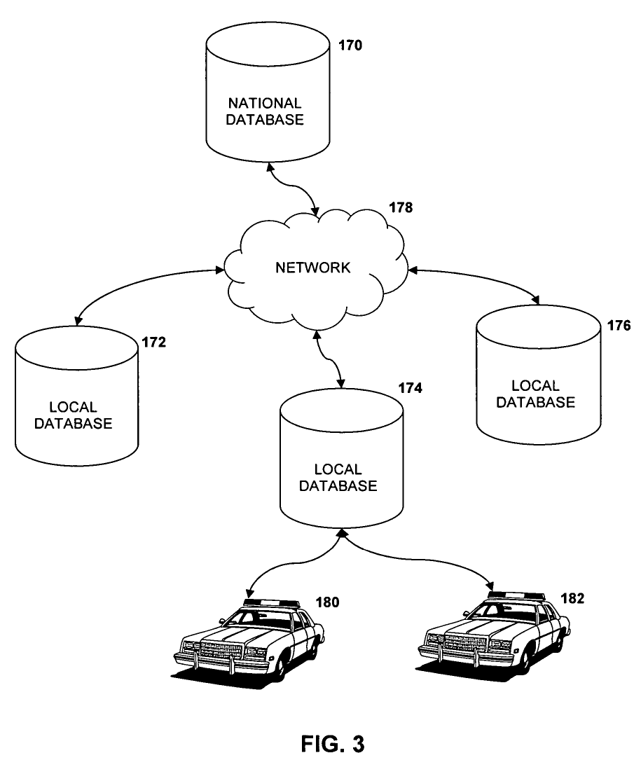

Referring now to FIG. 3, there is depicted a data distribution network that may be used to distribute data in accordance with the method and system of the present invention. As illustrated, national, or central, database 170 is connected to local databases 172-176 through network 178. National database 170 includes data regarding wanted vehicles for a large region, such as the entire country. Local databases 172-176 contain records for smaller areas, such as a city or state. Network 178 may be implemented with any of several known networking standards, such as, for example, the internet protocol standard TCP/IP and data transmitted via the Internet.

Information is typically provided or input into the database at the local level. Local personnel input data regarding vehicles, persons, types of offenses, and record ratings to be used as suggested threshold or criteria for triggering an alert. This information, once in a local database, or file server, is uploaded periodically (for example, each hour) to the national database. The national database, which serves as a clearing house, then distributes the information to the various local databases on a periodic basis. The local database then periodically distributes the information to the patrol vehicles. The distributed information is typically new or updated information, such as newly entered vehicle license numbers, and the like.

Updated information is typically provided to the local database. For example, if a vehicle that is wanted in connection with an offense is impounded, personnel input this information into the local database. Thereafter, the fact that a previously wanted vehicle is no longer wanted is sent to the national database, which then sends the information to the various local databases, and then onto the patrol vehicles. The patrol vehicles may receive this information with a flag that allows the old information to be deleted or overwritten by the new incoming information. Thus, the vehicles are provided with updated and current information.

It is important that the data or information used by the system be accurate and timely. In order to provide the information that the system needs, a central data collection system may be used to feed information to a network of local computers that reside within or near the local law enforcement agency offices. For example, the local computer system(s) may be in the building from which the transmitted data is sent via a radio tower. The present invention may be used to inject or multiplex the data updates into regular radio transmissions, such as radio dispatches to patrol vehicles.

The computer system may also be connected to the central data collection system by a phone line connection, like a dialup modem, or an Internet connection. This network connection may be used to keep the local computer updated on all the latest information required by officers in the field.

Official vehicles 180 and 182 receive database updates from one of the local databases, such as local database 174 as shown in FIG. 3. The database distribution system shown in FIG. 3 reduces the size of some data files, while still maintaining a communication path with other regions.

The central data collection facility that maintains national database 170 may use many different methods to collect data that needs to be disseminated to the field. For example, to collect data for stolen cars, a web page can be setup for individuals report stolen vehicles. This information can then be verified by a company representative or by the local police department after the data has been forwarded to that department. After verification, that data will be downloaded to all of the local area systems, which in turn will download it to the local mobile systems in the official vehicles.

The central data collection facility may grow to encompass many different roles for data collection and distribution on a nationwide or a worldwide basis.

In addition to database updates and current priority threshold updates, the system may also receive software updates, as depicted in block 158 of FIG. 5. Such software updates may change the programming in central processing unit 46, which in turn can change the operation and functions of the entire vehicle detection and alert system 38 (See FIG. 2).

Referring now to FIG. 8, there is depicted a schematic representation of a table in wanted vehicle database in accordance with the method and system of the present invention. In an actual implementation of the present invention, the database may include additional fields that are not shown in the example of FIG. 8. As illustrated, database 200 may include vehicle license field 202, vehicle description field 204, warrant field 206, and record rating field 208. Each record 210 in database 200 preferably includes the information of the types indicated by fields 202-208. Additional field types may also be included. Vehicle description field 204 may include, for example, the year, color, make, and model of the wanted vehicle. Warrant field 206 may describe the type of warrant for the person that is likely to be driving or riding in the wanted vehicle. Record rating field 208 may include a value, criteria, or other information that is used in determining whether or not a threshold has been exceeded and that the patrol officer should be alerted to a database match

Another field that may be included in records 200 is a field that includes special instructions or warnings regarding the person that is likely be driving or riding in the wanted vehicle. For example, the field may include information that the person is violent, or has a history of evading arrest.

The method and system of the present invention provides a complete system that can: identify a vehicle; search a national, distributed database; and alert an officer or user in a selectable, controllable, prioritized manner.

There are many financial reasons for law enforcement agencies to buy the system of the present invention. First, the fact that the system informs the officers (and makes a record) every time the officer comes close to a vehicle that needs some action taken. Second, the number of arrests may increase, and the number of stolen cars, unpaid parking tickets, and the like, may decrease dramatically, thereby increasing the efficiency of the patrol officers.

It would not be unusual for a city to determine that it has lost hundreds of thousands, if not millions of dollars, in unpaid parking tickets. There can be an ongoing effort by that city to stop and warn citizens to pay their tickets by the next time that they are stopped, or risk being arrested. This simple monitoring and enhanced enforcement may pay for the present system many times over.

A private business or concern can operate the databases, both nationally and locally. Database operation includes inputting data, deleting outdated information, insuring integrity of information for legal purposes, and distributing the data or information between the national and local databases, and between the local databases and the patrol vehicles or officers.

The system of the present invention may be operated at no cost to a city. For example, a private concern can build a database of unpaid parking tickets. When police officers identify offending vehicles and take corrective action, fines are likely to be paid. The private concern may be paid a percentage of the fine as payment for its services and equipment.

The foregoing description of a preferred embodiment of the invention has been presented for the purpose of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method of alerting a patrol officer of a wanted vehicle comprising the steps of:
providing a database of wanted vehicles, wherein records in the database include identifying characteristics and a record rating that indicates a type of warrant associated with the wanted vehicle;
setting a current priority threshold in a first vehicle;
using a camera on the first vehicle, capturing a digital image of a second vehicle;
processing the digital image to recognize identifying characteristics of the second vehicle;
querying the database of wanted vehicles for a record having the identifying characteristics; and
in response to finding a matching record having a record rating equal to or exceeding the current priority threshold, producing an alert in the first vehicle.

2. The method of alerting a patrol officer of a wanted vehicle according to claim 1 wherein the step of providing a database of wanted vehicles, wherein records in the database include identifying characteristics and a record rating that indicates a type of warrant associated with the wanted vehicle further includes providing a database of wanted vehicles, wherein records in the database include a record rating that indicates a severity of an offense associated with a person who is likely in the wanted vehicle.

3. The method of alerting a patrol officer of a wanted vehicle according to claim 1 wherein the step of processing the digital image to recognize identifying characteristics of the second vehicle further includes recognizing characters of a license plate on the second vehicle using optical character recognition.

4. The method of alerting a patrol officer of a wanted vehicle according to claim 1 wherein the step of producing an alert in the first vehicle further includes producing an alert in the first vehicle that indicates the position of the second vehicle relative to the first vehicle.

5. The method of alerting a patrol officer of a wanted vehicle according to claim 4 wherein the step of producing an alert in the first vehicle that indicates the position of the second vehicle relative to the first vehicle further includes displaying an indicator on a display that points in the direction of the second vehicle.

6. The method of alerting a patrol officer of a wanted vehicle according to claim 4 wherein the step of producing an alert in the first vehicle that indicates the position of the second vehicle relative to the first vehicle further includes displaying icons on a display indicating the relative positions of the first and the second vehicles.

7. The method of alerting a patrol officer of a wanted vehicle according to claim 4 wherein the step of producing an alert in the first vehicle that indicates the position of the second vehicle relative to the first vehicle further includes producing an audible alert indicating the relative positions of the first and the second vehicles.

8. The method of alerting a patrol officer of a wanted vehicle according to claim 7 wherein the step of producing an audible alert indicating the relative positions of the first and the second vehicles further includes producing speech using a speech-synthesized voice that indicates the position of the second vehicle.

9. The method of alerting a patrol officer of a wanted vehicle according to claim 1 wherein the step of setting a current priority threshold in a first vehicle further includes setting a current priority threshold in a first vehicle according to an input from within the first vehicle.

10. The method of alerting a patrol officer of a wanted vehicle according to claim 9 wherein the input from within the first vehicle is an input from a person within the first vehicle.

11. The method of alerting a patrol officer of a wanted vehicle according to claim 9 wherein the input from within the first vehicle is an input from a sensor that senses a condition within the first vehicle.

12. The method of alerting a patrol officer of a wanted vehicle according to claim 1 wherein the step of setting a current priority threshold in a first vehicle further includes setting a current priority threshold in a first vehicle according to an input received via a receiver in the first vehicle.

13. The method of alerting a patrol officer of a wanted vehicle according to claim 1 wherein the current priority threshold is based upon a type of warrant associated with the second vehicle.

14. The method of alerting a patrol officer of a wanted vehicle according to claim 1 wherein the current priority threshold is based upon a quantity of warrants associated with the second vehicle.

15. The method of alerting a patrol officer of a wanted vehicle according to claim 1 further including the step of receiving database updates in the first vehicle.

16. The method of alerting a patrol officer of a wanted vehicle according to claim 1 further including the step of receiving a command to change the current priority threshold in the first vehicle.

17. A system for alerting a patrol officer of a wanted vehicle comprising:
a camera for mounting on a first vehicle for capturing a digital image of a second vehicle;
a digital image processor coupled to the camera for processing the digital image to recognize identifying characteristics of the second vehicle;
a database management unit for receiving the identifying characteristics and querying a database of wanted vehicles using the identifying characteristics to find a matched record, wherein records in the database include vehicle identifying characteristics and a record rating that indicates a type of warrant associated with the wanted vehicle;
a central processing unit coupled to the database management unit for setting a current priority threshold in the first vehicle and for producing an alert signal in the first vehicle in response to the record rating in the matched record being equal to or exceeding the current priority threshold; and
an alerting device coupled to the central processing unit for producing an alert in the first vehicle in response to the alert signal.

18. The system for alerting a patrol officer of a wanted vehicle according to claim 17 wherein the digital image processor includes an optical character recognition system.

19. The system for alerting a patrol officer of a wanted vehicle according to claim 17 wherein the identifying characteristics of the second vehicle includes characters in a license plate.

20. The system for alerting a patrol officer of a wanted vehicle according to claim 17 wherein the identifying characteristics of the second vehicle includes a color and a type of vehicle.

21. The system for alerting a patrol officer of a wanted vehicle according to claim 17 wherein the record rating includes a severity rating of an offense associated with a person who is likely in the second vehicle.

22. The system for alerting a patrol officer of a wanted vehicle according to claim 17 wherein the alert in the first vehicle indicates the position of the second vehicle relative to the first vehicle.

23. The system for alerting a patrol officer of a wanted vehicle according to claim 17 wherein the alerting device further includes a display.

24. The system for alerting a patrol officer of a wanted vehicle according to claim 23 wherein the alert includes an indication on the display of the direction of the second vehicle relative to the first vehicle.

25. The system for alerting a patrol officer of a wanted vehicle according to claim 24 wherein the indication on the display includes an arrow indicating the direction of the second vehicle.

26. The system for alerting a patrol officer of a wanted vehicle according to claim 22 wherein the alert in the first vehicle indicates the position of the second vehicle relative to the first vehicle using a synthesized speech message.

27. The system for alerting a patrol officer of a wanted vehicle according to claim 17 further including a communication unit coupled to the central processing unit for receiving system updates.

28. The system for alerting a patrol officer of a wanted vehicle according to claim 27 wherein the system updates include updates to the database of wanted vehicles.

29. The system for alerting a patrol officer of a wanted vehicle according to claim 27 wherein the system updates includes new software to change a system function.

30. The system for alerting a patrol officer of a wanted vehicle according to claim 27 wherein the central processing unit sets the current priority threshold in response to data received from the communication unit.

31. The system for alerting a patrol officer of a wanted vehicle according to claim 27 wherein the central processing unit sets the current priority threshold in response to an input received from the communication unit.
